(19) United States
(12) Patent Application Publication
(10) Pub. No.: US 2005/0274001 A1
(43) Pub. Date: Dec. 15, 2005

(54) Electrodes having wiped edges

(75) Inventors: Jon K. West, Gainesville, FL (US); Thomas J. McCall, Ft. White, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/864,798

(22) Filed: Jun. 10, 2004

(51) Int. Cl. H01M 4/42

(52) U.S. Cl. 29/623.5; 425/113

(57) ABSTRACT

A method and apparatus for extruding materials, including electrolytically active materials, onto metallic substrates used in the production of electrodes. The method and apparatus facilitates the production of improved electrodes for use in energy storage devices, such as rechargeable batteries. A preferred device may include a base, a spreader, edge guides and wipers. The wipers, or doctor blades, clean a portion of the substrate during the extrusion process. This provides a clean edge on which a current collector can be welded. The clean edge enables an electrode that is more reliable, more easily used during the battery manufacturing process, and may also provide for lower internal resistance of the energy storage cell.

### FIELD OF THE INVENTION

The disclosure relates to a novel method and device for depositing materials, including electrolytically active materials, onto metallic substrates used in the production of electrodes. More particularly, the disclosed method and device, in its various embodiments, facilitates the production of improved electrodes for use in energy storage devices, such as rechargeable batteries.

### BACKGROUND OF THE RELATED ARTS

For many years, extrusion has been used to deposit a layer of electrolytically active material, such as NiMH, onto metallic substrates when making electrodes used in energy storage cells. One problem with known extruders is that they deposit a layer of active material across the entire width of the substrate. This results in a coated substrate that has very little suitable space to which a current collected can be welded. The electrode may also suffer from decreased performance and unreliability due to damage caused to the active material during the welding process. This is due to the expulsion of active material from the weld zone.

It would therefore be desirable to have an extruder and a method for making electrodes for energy storage cells that provided a more suitable surface for attaching a current collector, reduced internal resistance, and greater reliability.

It would also be desirable to have an electrode having a layer of electrolytically active material deposited thereon by extrusion, spraying, painting, or other means that includes a clean-wiped edge to enhance the performance of the electrode when used in an energy storage device.

### SUMMARY OF THE INVENTION

In a preferred embodiment, a method and system in accordance with the present invention relates to forming a layer of active material, including electrolytically active material, typically in paste form, onto a metallic substrate to form an electrode for use in an energy storage cell. In one preferred embodiment a nickel metal hydride paste may be extruded onto a nickel-plated steel substrate. The extruder may include a wiper for producing a strip having a clean, or wiped, edge that provides a surface for contacting a current collector. Alternatively, a system and method in accordance with the present invention relates to creating a wiped-edge on a substrate that has been coated with an electrolytic material by means other than extrusion, such as painting, spraying, etc.

In another illustrative embodiment, a nickel hydroxide layer may be formed on the substrate which is then run through a die having a wiper. The wiper allows for the production of an electrode having a wiped-edge which provides improved contact with a current collector in comparison to prior art electrodes.

In another illustrative embodiment, a pure metal slurry or metal alloy slurry may be applied to the substrate. The metal slurry or metal alloy slurry may comprise a number of components. By way of example and without limitation, the components may include electrolytically active or electrolytically non-active material, transition or non-transition metals, lithium, aluminum, carbon, or admixtures and combinations thereof.

In another illustrative embodiment, the die or extruder may have multiple wipers, or single wipers, or one or more central spaces for wiping an interior portion of the paste layer, or combinations thereof. In another embodiment of the present system, the wiper or wipers provide a substantially uniform wiped surface.

### BRIEF DESCRIPTION OF THE DRAWING FIGURES

FIG. 1 illustrates interior cross section of an embodiment of an extruder according to the present disclosure.

FIG. 2 illustrates an exploded view of a first half of a extruder for creating a wiped edge on a substrate.

FIG. 3 illustrates an exploded view of a second half of a extruder for creating a wiped edge on a substrate.

FIG. 4 illustrates an exploded view of an embodiment of an entrance plate for use in an extruder according to the present invention.

FIG. 5 shows a paste spreader plate according to an embodiment of the extruder of the present invention.

FIG. 6 shows an exemplary spacer for use in an extruder.

FIG. 7 shows an illustrative wiper for use in removing a portion of an extruded layer from a metallic substrate.

FIG. 8 shows another embodiment of a wiper for use in removing a portion of an extruded layer from a metallic substrate.

FIG. 9 illustrates one embodiment of an exit plate for use in an extruder.

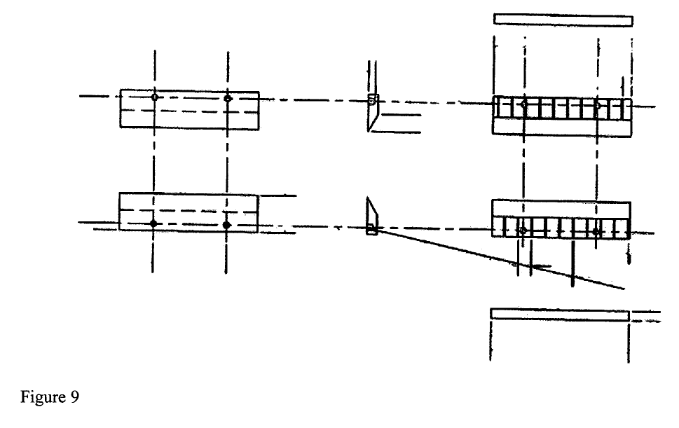

FIG. 10 illustrates a coated substrate having a wiped edge.

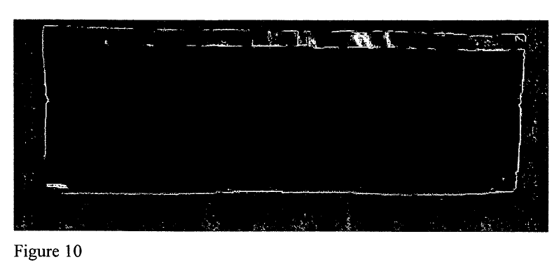

FIG. 11 illustrates a perforated substrate being coated by an extruder die and including wipers for producing a wiped edge on the substrate.

### DETAILED DESCRIPTION OF THE INVENTION

The present invention, in a preferred embodiment, relates to an electrical energy storage device and, more specifically, to rechargeable storage cells. By way of example and illustration, the present specification describes D-Cell batteries. It is noted, however, each of the principles and discoveries mentioned herein apply with equal weight to cells having a coiled energy storage device, such as AA, AAA, C, for example, and cells that do not use cylindrically wound coils like prismatic batteries, oval cells, etc.

Particularly, the present specification relates to a novel apparatus for extruding electrolytically active material, electrolytically inactive material, transition metals (generally in the form of a slurry) onto metallic substrates for use in forming electrodes. Such electrodes may be used in energy storage device such as rechargeable battery cells. Exemplary energy storage devices for us in accordance with the presently disclosed system and method are described in U.S. Pat. No. 6,265,098, U.S. Pat. No. 5,667,907, U.S. Pat. No. 5,439,488, and U.S. Pat. No. 5,370,711, each of which is hereby incorporated by reference in its entirety.

One aspect of creating coiled energy storage devices is that prior art extruders are designed to apply a layer of electrolytically active material over the entire width of a metal substrate. When a current collector is welded to such a substrate, the electrolytically active material adjacent to the weld can be damaged, deteriorating cell performance. The present disclosure, however, relates to an extruder for NiMH and other electrolytically active materials, which make welding possible and reliable.

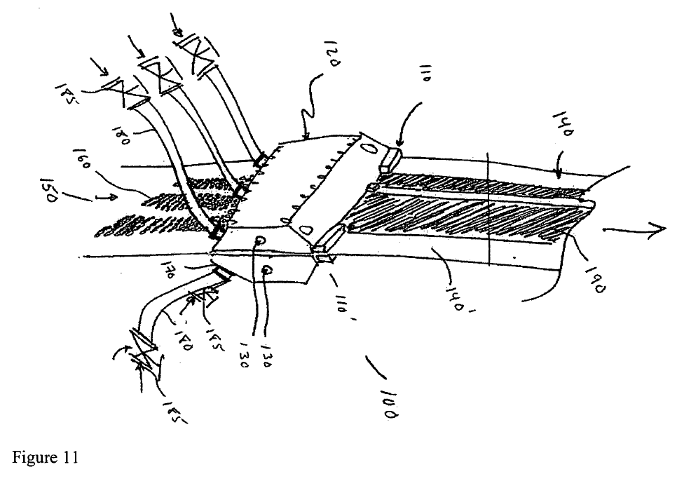

An extruder suitable for use in accordance with the present invention may include a base, a spreader, edge guides, and wipers. One view of such an extruder is illustratively shown in FIG. 11. The wipers 110, 110′, or doctor blades, clean a portion of the substrate 150, during the extrusion process, to provide a clean edge 140, 140′ whereupon a current collector can be welded. The provision of such a clean edge allows for the creation of an electrode that is more reliable, more easily used during the battery manufacturing process, and may also provide for lower internal resistance of the energy storage cell.

The extruder of FIG. 11 includes a die 120 having optional inlet ports 130, 130′ for the introduction of a temperature controlled fluid into the die. The use of a temperature controlled fluid in the die may improve the thermal stability of the extruder and enhance performance. To produce a substrate having an extruded layer thereon with a wiped edge, a substrate 150 enters the die. The substrate may include perforations 160. The perforations 160 may improve the adherence of the extruded layer to the substrate. A paste can be introduce into the extruder die 120 via feed lines 180 connecting to inlet ports 170. The paste flow may be regulated by control valves 185. The substrate 150 passes through the die 120 and an extruded layer 190 is coated thereupon. Wipers 110, 110′ remove a portion of the extruded layer 190 to produce a substrate having a wiped edge.

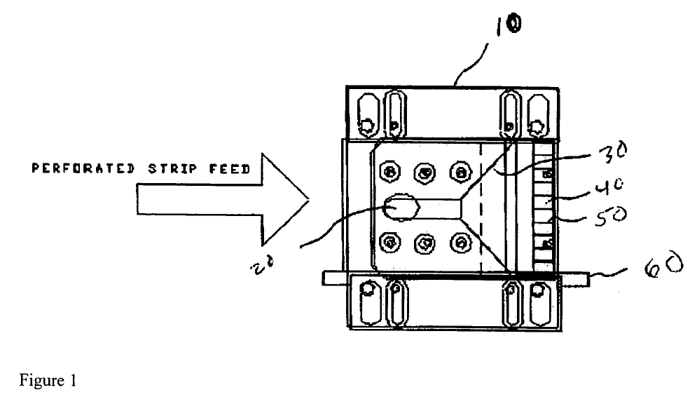

An embodiment of an illustrative extruder is shown in FIG. 1. Such an extruder 10 may include an inlet port 20 through which a paste, or slurry, enters the extruder. The inlet port 20 may be angled to avoid inducing excess pressure in the paste feed system. A typical angle of about 45 degree is preferred, particularly when a nickel metal hydride (NiMH) is the electrolytically active material. Many suitable angles may be found for pastes having different viscosities.

The extruder may further include an outwardly expanding exit port 30, or spreader, to ensure an even flow of paste across the width of the substrate being coated. Adjustable exit guides 40 having grooves 50 may be provided to control the thickness of the paste layer on the substrate, as well as the pressure within the extruder. A doctor blade, or wiper, 60 may be provided to limit the formation of the paste layer to a desired portion of the substrate.

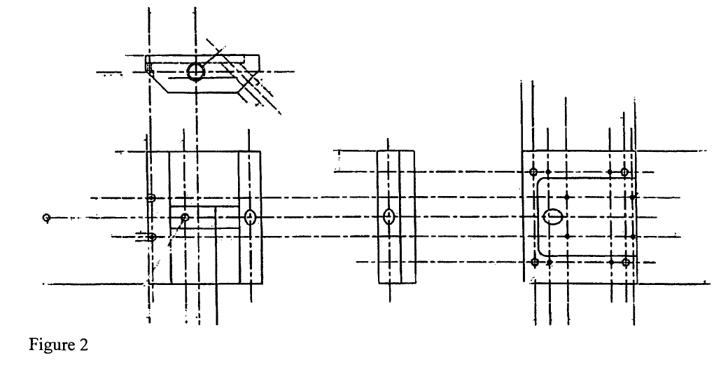

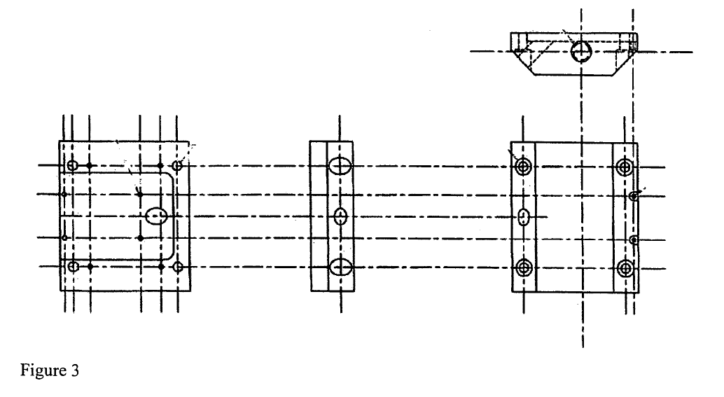

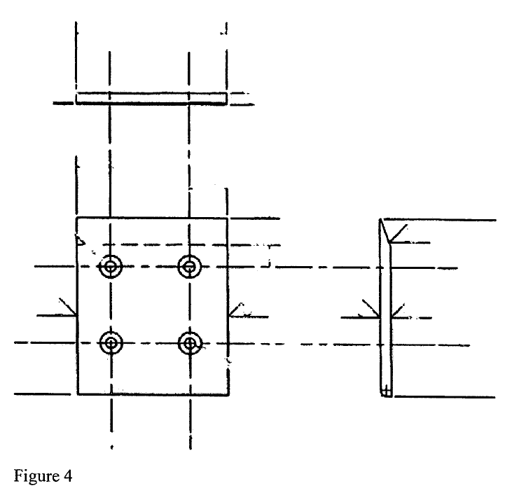

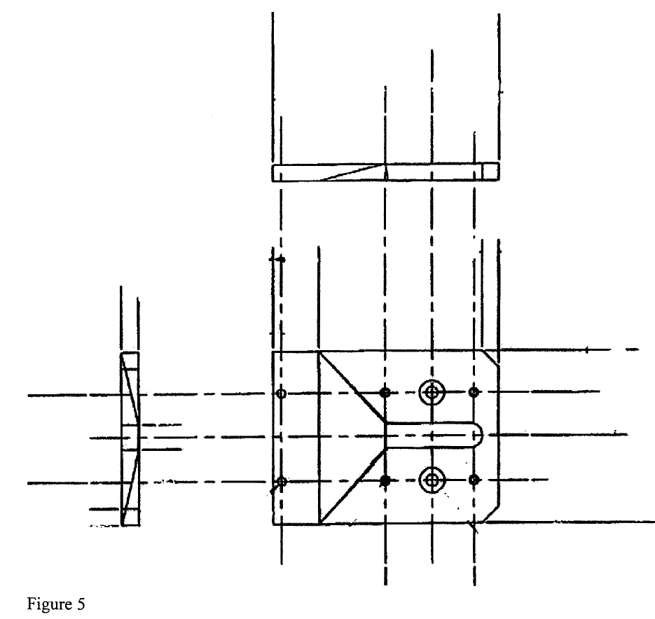

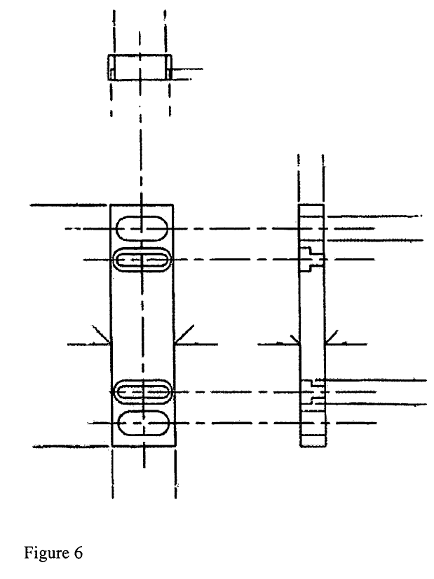

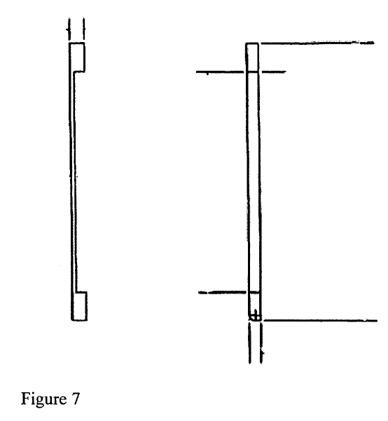

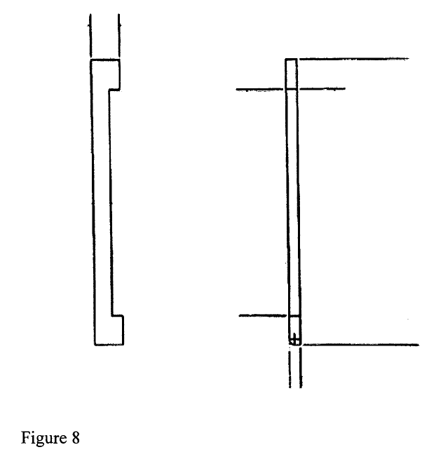

The frames of the extruder are illustrated in more detail in FIGS. 2 and 3. An entrance plate, as shown in FIG. 4, is provided in advance of a paste spreader plate which is illustrated by FIG. 5 and including the expanding exit port 30 which is shown in FIG. 1. The adjustable exit guides 40 shown in FIG. 1 are illustrated in greater detail in FIG. 6 with the exit plate having grooves 50 being showing in FIGS. 1 and 5 (FIG. 5 shows grooved die inserts in greater detail). Finally, FIGS. 7 and 8 show various wipers for use in accordance with the present system for providing a metallic substrate with one or more wiped edges.

FIG. 11 illustrates an exemplary extruder for producing a substrate having a wiped edge. This figure shows an optional feature for circulating a temperature controlled fluid through the die for improving thermal stability.

Alternatively, the device may be configured to create a wiped edge on an electrode being formed by alternate means. Although the use of a doctor blade may be preferred for removing material that has been deposited on a metallic substrate, other means may be employed within the scope of the invention. For example, an adhesive strip may be placed on the metallic substrate prior to depositing the electrolytically active or inactive material thereon. The tape may then be removed, exposing a wiped edge or center strip on the electrode. Another method may include manually scraping or wiping the material that is deposited on the metallic substrate to produce a surface on the electrode that is free of the electrolytically active or inactive material.

### EXAMPLE 1

Coating a Nickel-Plated Steel Substrate

A nickel-plated steel substrate is provided and fed to the strip feed portion of the extruder. A NiMH paste is introduced through a 45 degree inlet port at about 5-100 psi of pressure, depending on the plate design and density. The paste is guided via the outwardly expanding spreader and contacts the substrate, which then moves through the die and is kept centered by means of edge guides. Prior to beginning the extruding process, the edge guides are adjusted to limit the thickness of the paste layer.

As the strip exits the extruder, a wiper cleans a portion of the paste layer from the substrate to provide a clean edge, thus forming an electrode. When coiled, the cleaned edge provides an excellent surface on which to establish contact between current collector and electrode. Depending on the width of the substrate used, a space may be inserted into the exit guides to wipe a strip of paste from the central area of the substrate. This may permit the strip to be slit, allowing multiple electrodes to be manufactured simultaneously.

An energy storage device in accordance with the present invention may be used for storing and supplying energy in a variety of different environments and for a variety of different purposes. For example, an energy storage device in accordance with the present invention may be used for storing and supplying energy in transportation vehicles, including for example ground transportation vehicles, air transportation vehicles, water surface transportation vehicles, underwater transportation vehicles, and other transportation vehicles. An energy storage device in accordance with the present invention may be used for storing and supplying energy in communication and entertainment devices, including for example telephones, radios, televisions and other communication and entertainment devices. An energy storage device in accordance with the present invention may be used for storing and supplying energy in home appliances, including for example flashlights, emergency power supplies, and other home appliances. The examples described in this paragraph are merely representative, not definitive.

1. A method of making an electrode, the method comprising:
providing a metal substrate,
establishing a layer of a first material on at least a portion of the substrate during relative movement between the substrate and a first material extruder,
preventing a layer of the first material from being established on at least a portion of the substrate during relative movement between the substrate and the first material extruder,
whereby a pattern of the first material is established on the substrate.

2. A method of making an electrode, the method comprising:
providing a metal substrate,
establishing a layer of a first material on at least a portion of the substrate during relative movement between the substrate and a first material extruder,
removing a layer of the first material from at least a portion of the substrate during relative movement between the substrate and the first material extruder,
whereby a pattern of the first material is established on the substrate.

3. A method of making an electrode, the method comprising:
providing a metal substrate,
establishing a layer of first material on multiple portions of the substrate during relative movement between the substrate and a first material extruder,
preventing a layer of the first material from being established on multiple portions of the substrate during relative movement between the substrate and the first material extruder,
whereby a pattern of the first material is established on the substrate.

4. A method of making an electrode, the method comprising:
providing a metal substrate,
establishing a layer of a first material on at least a portion of the substrate during relative movement between the substrate and a first material extruder,
removing a layer of the first material from multiple portions of the substrate during relative movement between the substrate and the first material extruder,
whereby a pattern of the first material is established on the substrate.

5. A device for making an electrode, the device comprising:
a first material extruder,
means for establishing relative movement between the first material extruder and a metal substrate,
the first material extruder being configured for establishing a layer of a first material on at least a portion of the substrate during relative movement between the substrate and the first material extruder and for preventing a layer of the first material from being established on at least a portion of the substrate during relative movement between the substrate and the first material extruder.

6. A device for making an electrode, the device comprising:
a first material extruder,
means for establishing relative movement between the first material extruder and a metal substrate,
the first material extruder being configured for establishing a layer of a first material on at least a portion of the substrate during relative movement between the substrate and the first material extruder and for removing a layer of the first material from at least a portion of the substrate during relative movement between the substrate and the first material extruder.

7. A device for making an electrode, the device comprising:
a first material extruder,
means for establishing relative movement between the first material extruder and a metal substrate,
the first material extruder being configured for establishing a layer of a first material on multiple portions of the substrate during relative movement between the substrate and the first material extruder and for preventing a layer of the first material from being established on multiple portions of the substrate during relative movement between the substrate and the first material extruder.

8. A device for making an electrode, the device comprising:
a first material extruder,
means for establishing relative movement between the first material extruder and a metal substrate,
the first material extruder being configured for establishing a layer of first material on multiple portions of the substrate during relative movement between the substrate and the first material extruder and for removing a layer of first material from multiple portions of the substrate during relative movement between the substrate and the first material extruder.

9. A method of making an electrode, the method comprising:
providing a metal substrate,
establishing a layer of a first material on at least a portion of the substrate,
preventing a layer of the first material from being established on at least a portion of the substrate,
whereby a pattern of the first material is established on the substrate.

10. A method of making an electrode, the method comprising:
providing a metal substrate,
establishing a layer of a first material on at least a portion of the substrate,
removing a layer of the first material from at least a portion of the substrate,
whereby a pattern of the first material is established on the substrate.

11. A method of making an electrode, the method comprising:
providing a metal substrate,
establishing a layer of first material on multiple portions of the substrate,
preventing a layer of the first material from being established on multiple portions of the substrate,
whereby a pattern of the first material is established on the substrate.

12. A method of making an electrode, the method comprising:
providing a metal substrate,
establishing a layer of a first material on at least a portion of the substrate,
removing a layer of the first material from multiple portions of the substrate,
whereby a pattern of the first material is established on the substrate.

13. A device for making an electrode, the device comprising:
a first material applicator,
means for relatively positioning the first material applicator and a metal substrate,
means for establishing a layer of a first material on at least a portion of the substrate, and
means for preventing a layer of the first material from being established on at least a portion of the substrate.

14. A device for making an electrode, the device comprising:
a first material applicator,
means for relatively positioning the first material applicator and a metal substrate,
means for establishing a layer of a first material on at least a portion of the substrate, and
means for removing a layer of the first material from at least a portion of the substrate.

15. A device for making an electrode, the device comprising:
a first material applicator,
means for relatively positioning the first material applicator and a metal substrate,
means for establishing a layer of a first material on multiple portions of the substrate, and
means for preventing a layer of the first material from being established on multiple portions of the substrate.

16. A device for making an electrode, the device comprising:
a first material applicator,
means for relatively positioning the first material applicator and a metal substrate,
means for establishing a layer of a first material on multiple portions of the substrate, and
means for removing a layer of first material from multiple portions of the substrate.

17. The method of any of claims 1-4 and 9-12 wherein the first material comprises an electrolytic material.

18. The device of any of claims 5-8 and 13-16 wherein the first material comprises an electrolytic material.

19. An electrode made in accordance with the method defined in any of claims 1-4 and 9-12.

20. An energy storage device comprising the electrode of claim 19.
